(19) United States
(12) Patent Application Publication
(10) Pub. No.: US 2003/0095404 A1
(43) Pub. Date: May 22, 2003

(54) Impact resistant trouble light

(76) Inventors: Eric R. Becks, Cheboygan, MI (US); Thomas F. Gauthier, Cheboygan, MI (US); Donald L. Russell, Lebanon, IN (US)

Correspondence Address: John Wiley Horton, Pennington, Moore, Wilkinson, Bell & Dunbar, P.A., 2nd Floor, 215 S. Monroe St., Tallahassee, FL, 32301, US

(21) Appl. No.: 10/331,404

(22) Filed: Dec. 30, 2002

Related U.S. Application Data
(63) Continuation-in-part of application No. 09/682,798, filed on Oct. 19, 2001.

(51) Int. Cl. F21L 4/02

(52) U.S. Cl. 362/185; 362/184; 362/800; 362/543; 362/545; 362/240; 362/369

(57) ABSTRACT

A novel light wherein the source of illumination is an array of light emitting diodes mounted on a printed circuit board. The board is contained within an impact resistant housing. Several different embodiments are disclosed for the housing, including injection molded and extruded variants.

### FIELD OF THE INVENTION

This invention relates to the field of lighting. More specifically, the invention comprises a work light employing a plurality of light emitting diodes arrayed on a printed circuit board.

### DESCRIPTION OF THE RELATED ART

“Work lights” or “trouble lights” are typically used in repair settings, such as work on automobiles, tractors, or industrial equipment. Such lights are typically equipped with a hanging hook to allow hands-free operation. They typically include a common incandescent bulb protected by a wire or plastic cage. Electrical power is supplied by batteries or AC line voltage.

### BRIEF SUMMARY OF THE PRESENT INVENTION

The present invention comprises a novel light wherein the source of illumination is an array of light emitting diodes mounted on a printed circuit board. The board is contained within an impact resistant housing. Several different embodiments are disclosed for the housing, including injection molded and extruded variants.

### BRIEF DESCRIPTION OF THE SEVERAL VIEWS OF THE DRAWINGS

FIG. 1 is an exploded isometric view, showing the components of the present invention.

FIG. 1B is an exploded isometric view, showing the components of the present invention.

FIG. 2 is an isometric view, showing the printed circuit board in detail.

FIG. 3 is an isometric view, showing the invention in its assembled state.

FIG. 4 is an exploded isometric view, showing an injection molded variant of the present

FIG. 5 is an isometric view, showing the injection molded variant in its assembled state.

FIG. 6 is an exploded isometric view, showing a second injection molded variant of the present invention.

FIG. 7 is an isometric view, showing the second injection molded variant in its assembled state.

REFERENCE NUMERALS IN THE DRAWINGS

| | | | |
|---|---|---|---|
| 2 | LED | 4 | current limiting device |
| 5 | circuit board | 6 | enclosure tube |
| 7 | power means | 20 | strain relief |
| 22 | seating flange | 24 | electrical connection |
| 26 | spacer ring | 28 | grip |
| 30 | cap | 32 | hook |
| 34 | lower enclosure tube | 36 | upper enclosure tube |
| 38 | light opening | 40 | clear window |
| 42 | left enclosure tube | 44 | right enclosure tube |
| 46 | alignment pin | 48 | gasket |

### DETAILED DESCRIPTION OF THE INVENTION

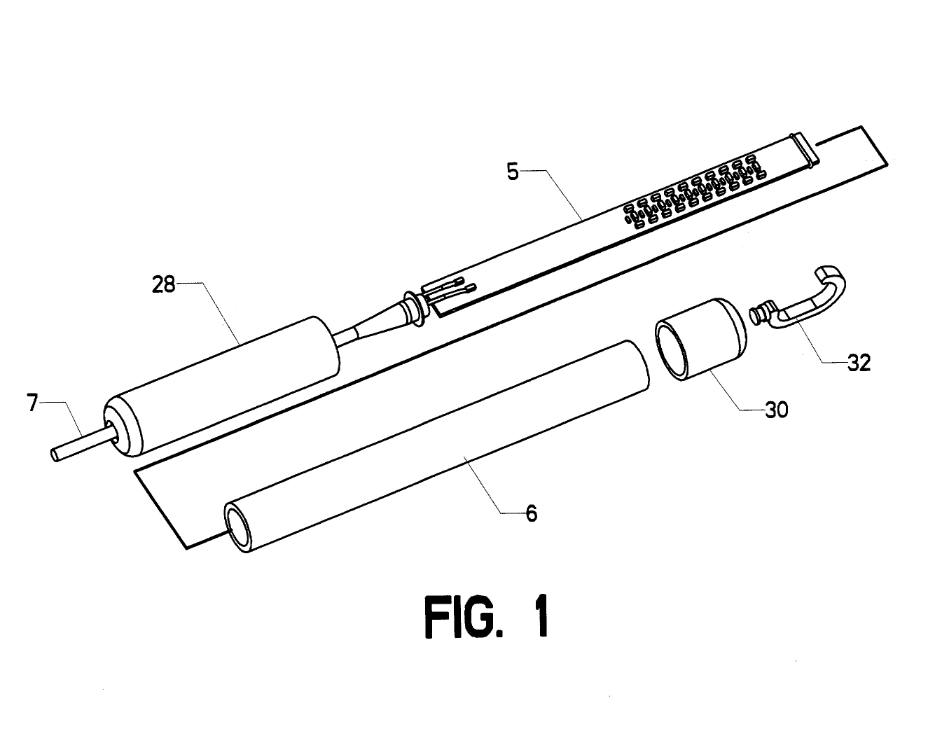

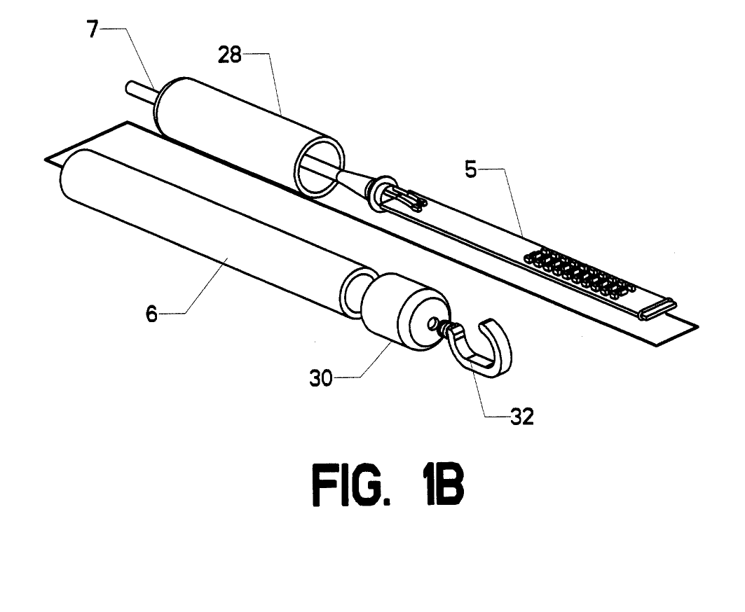

FIG. 1 is an exploded view of the proposed invention. Circuit board 5 is electrically connected to power means 7. A preferably elastic grip 28 is placed over the cord of power means 7. Enclosure tube 6 has a first open end, a second open end, and a hollow interior. It is preferably made as a transparent hollow cylinder. Enclosure tube 6 is sized to slide over circuit board 5, so that circuit board 5 resides within its hollow interior.

Grip 28 covers the first open end of enclosure tube 6. Cap 30, a hollow shell structure with one open end and one closed end, covers the second open end of enclosure tube 6. It is equipped with hook 32 (snapped into place or otherwise conventionally connected), which can be used to hang the completed assembly in order to allow the user to employ the device in a hands-free fashion. FIG. 1B shows the same assembly from another perspective. The reader will observe that grip 28 is likewise a hollow shell structure with one open end and one closed end.

Enclosure tube 6 is preferably a tough clear plastic extrusion. Grip 28 and cap 30 are preferably made of pliable material, such as synthetic rubber. They are ideally capable of stretching to expand somewhat in diameter.

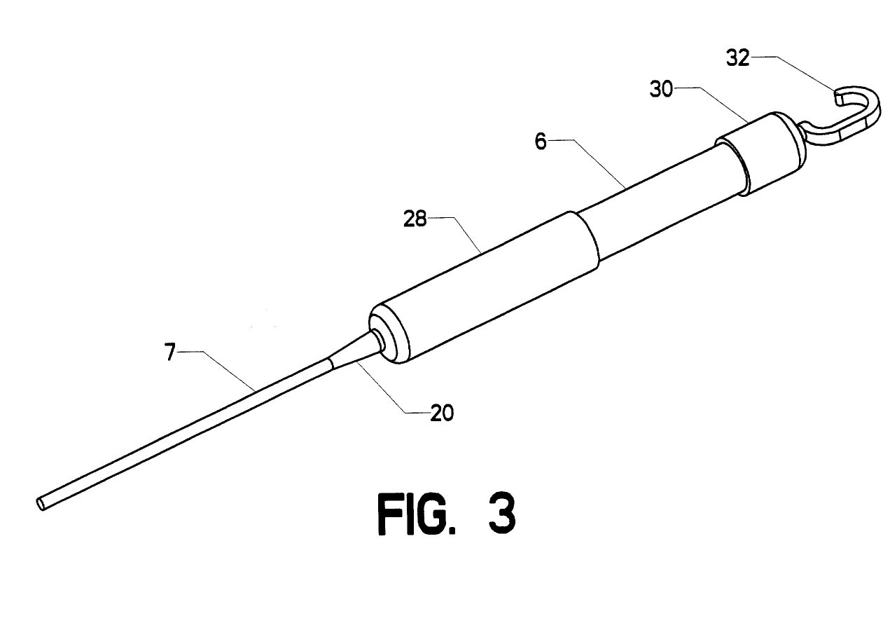

FIG. 3 shows the device in its assembled state. Using FIGS. 1, 1B, and 3, the assembly of the device can be readily understood: Enclosure tube 6 slides over circuit board 5 so that circuit board 5 rests within its hollow interior. Cap 30 (with optional hook 32) then slides over the second open end of enclosure tube 6. The diameter of the hollow interior within cap 30 is preferably made smaller than the external diameter of enclosure tube 6, so that it frictionally engages and remains fixed in position on enclosure tube 6.

Grip 28 then slides over the opposite end of enclosure tube 6. The diameter of the hollow interior of grip 28 is also sized to frictionally engage enclosure tube 6. The two open ends of enclosure tube 6 are thereby scaled. It may be desirable to add adhesive or sealant between the grip, cap, and enclosure tube, in order to create a water-tight seal. However, by carefully selecting the materials and sizing the parts, it is possible to make an effective seal without the use of adhesives or sealants.

The electrical cord of power means 7 passes through a hole in grip 28. Thus, grip 28 can be installed by sliding it along the power cord until it slips over enclosure tube 6 and reaches the position shown in FIG. 3. A sealing flange is provided around the strain relief on the power cord in order to seal the hole in grip 28 once it is in its assembled position. An adhesive can be used to increase the integrity of this seal.

Strain relief 20 is provided to allow grip 28 to slide along the power cord while still maintaining a water tight or water resistant seal as to the hole through grip 28. Thus, in the state shown in FIG. 3, the unit is water resistant. With the addition of adhesives or sealants, the unit can be made water-tight.

Those skilled in the art will realize that material selection can be employed to eliminate the use of adhesives. If, as an example, enclosure tube 6 is extruded from clear acrylic, it will be quite rigid and tough. If cap 30 and grip 28 are then made of an elastic material (such as various synthetic rubbers), the assembly of these elements onto enclosure tube 6 can form a good seal even without adhesives (while also allowing subsequent disassembly). The reader will therefore appreciate that the assembly process shown in FIGS. 1, 1B, and 3 allows the assembly of this embodiment's components without using separate fasteners.

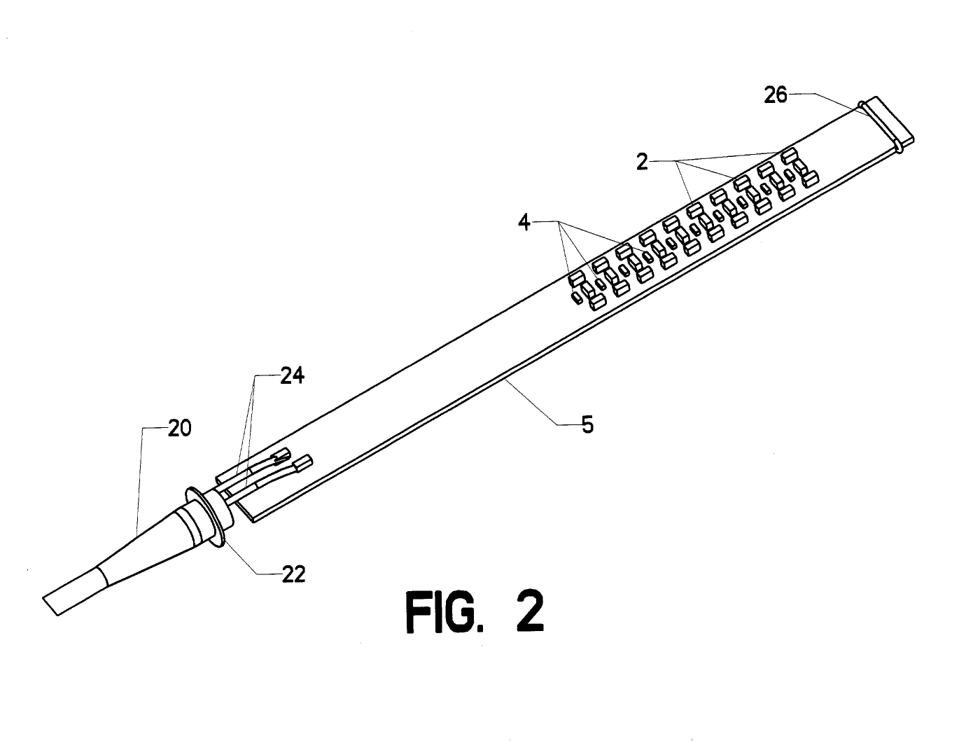

FIG. 2 shows circuit board 5 in more detail. It is preferably made as a conventional printed circuit board used in modem electronic devices. Power is provided via electrical connections 24 to power means 7. A plurality of light emitting diodes (“LED's”) 2 are mounted on circuit board 5 by conventional means, such as using the surface mount or dual in-line (DIP) placement approaches. Parallel circuits of LED clusters, with each cluster comprising a group of LED's connected in series, may be formed. Current limiting devices 4 are preferably added to prevent excess current flowing through any portion of the electrical circuit. These typically assume the form of chip resistors.

Circuit board 5 preferably distributes the electrical power through the use of printed traces, masks, conductive through-holes, and solder connections - all of which are familiar to those in the electronics industry. However, the term “circuit board” should not be limited to mean only a conventional printed circuit board. It is more generally understood to be a structural element used to mount the LED's. For instance, one could use a ceramic substrate to mount the LED's while making the necessary electrical connections through conventional wiring.

Strain relief 20 is provided to connect the power cord to grip 28. Seating flange 22 snaps into the hollow interior of grip 28, while the balance of strain relief 20 remains on the outside. Once grip 28 is in place over enclosure tube 6, strain relief 20 tends to transmit forces placed on the power cord to enclosure tube 6 rather than to circuit board 5.

Although enclosure tube 6 does not have to be entirely transparent, the portion lying over the LED's must be in order to allow the light to escape the assembly. Those skilled in the art will realize that enclosure tube 6 can assume many forms. The version shown in FIGS. 1, 1B, and 3 is advantageous, since the thick-walled cylinder of enclosure tube 6 is quite tough. However, this version does not lend itself to certain mass production techniques - such as injection molding.

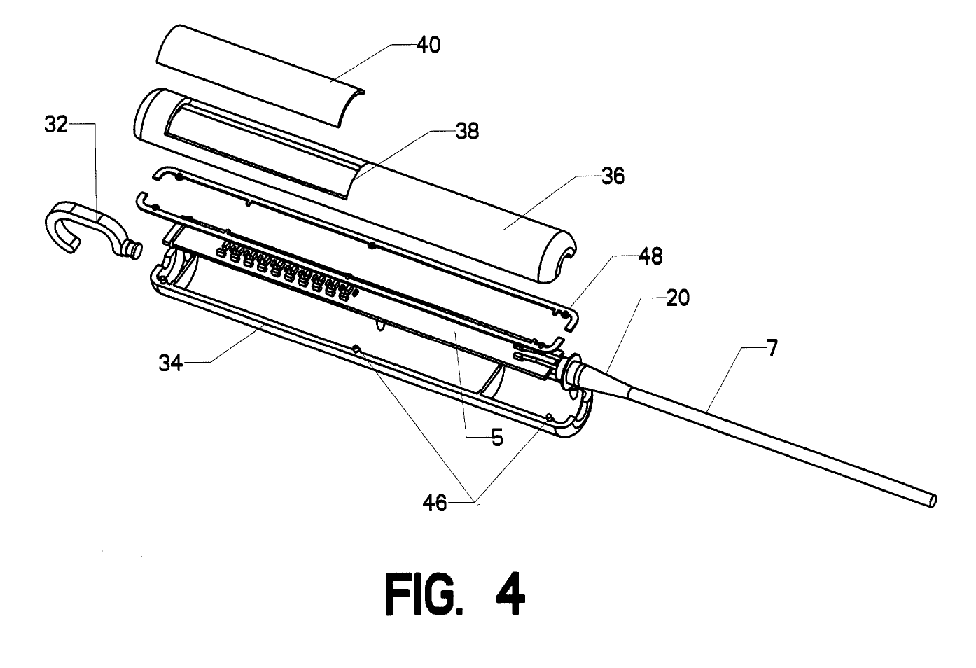

FIG. 4 shows an alternate embodiment for the enclosure tube, in which it is split into upper enclosure tube 36 and lower enclosure tube 34 (essentially two halves). Those skilled in the art will know that the shapes shown lend themselves to injection molding using thermoplastics. When the two halves are joined a hollow interior is formed, into which circuit board 5 is placed. Features are molded into the two halves to hold circuit board 5, capture strain relief 20, and capture hook 32. Alignment pins 46 mate with corresponding holes on the other half. Adhesives, ultrasonic welding, or fasteners can then be used to join the two halves. Alternatively, conventional plastic snapping features can be used.

A water-tight seal can be created by using selected adhesives to join the two halves. However, if the two halves are joined using plastic snapping features, then it may be necessary to add a sealing member such as gasket 48 between the two halves.

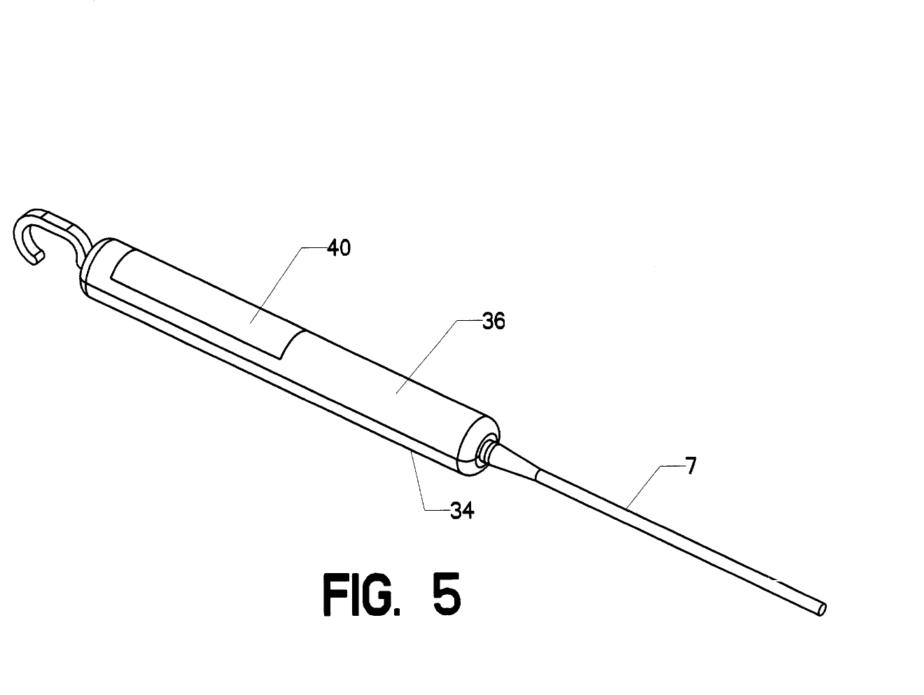

It is possible to mold the two halves from optically clear material. A portion can then be masked and painted to render it opaque - leaving a clear window over the LED's on circuit board 5. Alternatively, the two halves can be molded of opaque materials. A light opening 38 is then added over the LED's. Clear window 40 covers this opening. It is held in place by snaps, adhesives, or mechanical capturing between the two halves of the enclosure tube. FIG. 5 shows this embodiment in its assembled state, with window 40 in place. Conventional prior art seals - such as rubber gaskets or adhesives—must be employed to make window 40 watertight.

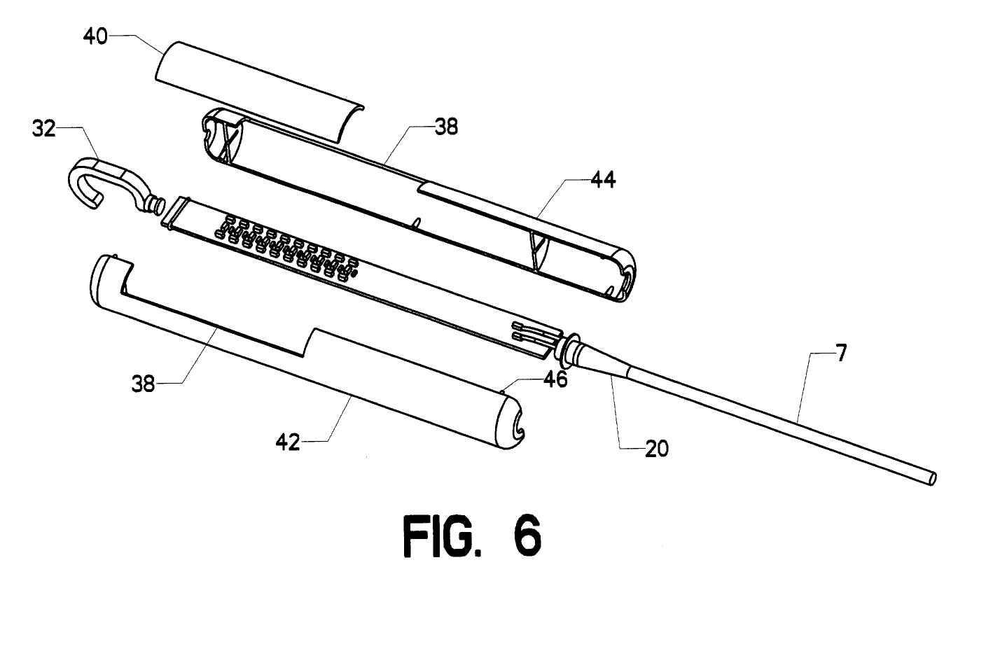

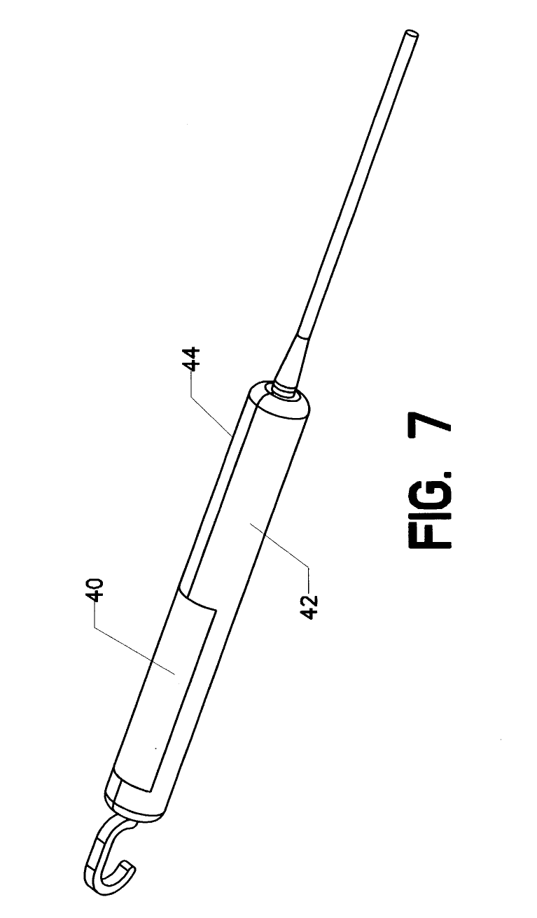

Those familiar with the design of injection molded parts will realize that endless variations are possible. FIG. 6 shows one such variation in which the enclosure tube is split in a different plane. Left enclosure tube 42 and right enclosure tube 44 are joined to form a seam which is perpendicular to the plane of circuit board 5. Joining in this plane can allow the convenient fixation of circuit board 5 in the assembly, using features molded into the two halves. The two halves can be joined by a variety of means, as explained previously. FIG. 7 shows the completed assembly.

An embodiment is also possible where the enclosure tube is split into two halves which join near the middle of the length of circuit board 5 (the joint would be in a plane which is parallel to the plane of seating flange 22).

Although the preceding description contains significant detail, it should not be construed as limiting the scope of the invention but rather as providing illustrations of the preferred embodiments of the invention. Accordingly, the scope of the invention should be construed according to the following claims and not by the examples given.

1. An impact resistant trouble light, comprising:
a. a circuit board;
b. a plurality of light emitting diodes affixed to said circuit board in any desired pattern;
c. an enclosure tube, having a first open end and a second open end, surrounding and protecting said circuit board, wherein the portion of said enclosure tube lying over said plurality of light emitting diodes is transparent in order to allow the light produced by said plurality to escape said enclosure tube;
d. power means for providing electrical power to said plurality of light emitting diodes so as to cause them to produce light;
e. a grip, having an open end opening into a hollow interior, wherein said open end is placed over said first open end of said enclosure tube so that said grip frictionally engages said enclosure tube and closes said first open end of said enclosure tube; and
f. a cap, having an open end opening into a hollow interior, wherein said open end is placed over said second open end of said enclosure tube so that said cap frictionally engages said enclosure tube and closes said second open end of said enclosure tube:

2. An impact resistant trouble light as recited in claim 1, wherein the connection between said power means and said plurality of light emitting diodes includes current limiting means.

3. An impact resistant trouble light as recited in claim 1, wherein said enclosure tube, said grip, and said cap combine to form a water resistant seal around said circuit board.

4. An impact resistant trouble light as recited in claim 1 further comprising a hook for hanging said trouble light.

5. An impact resistant trouble light as recited in claim 1, wherein said circuit board further comprises a spacer ring positioned to engage said enclosure tube and hold said circuit board with respect to said enclosure tube.

6. An impact resistant trouble light, comprising:
a. an enclosure tube, divided into a first half and a second half, wherein said first half and said second half may be joined along a seam to form a hollow interior therebetween, and wherein said enclosure tube includes a transparent portion;
b. a circuit board placed within said hollow interior of said enclosure tube;
c. a plurality of light emitting diodes affixed to said circuit board in any desired pattern proximate said transparent portion of said enclosure tube; and
d. power means for providing electrical power to said plurality of light emitting diodes so as to cause them to produce light.

7. An impact resistant trouble light as recited in claim 6, wherein the connection between said power means and said plurality of light emitting diodes includes current limiting means.

8. An impact resistant trouble light as recited in claim 6, wherein said enclosure tube forms a water resistant seal around said circuit board.

9. An impact resistant trouble light as recited in claim 6, further comprising a gasket placed between said first and second halves of said enclosure tube so as to form a water resistant seal.

10. An impact resistant trouble light as recited in claim 6 further comprising a hook for hanging said trouble light.

11. An impact resistant trouble light as recited in claim 6, wherein said enclosure tube includes a grip, allowing said enclosure tube to be more easily grasped by a user.
